(19) United States
(12) Patent Application Publication
(10) Pub. No.: US 2023/0415897 A1
(43) Pub. Date: Dec. 28, 2023

(54) FLEXIBLE AIRCRAFT PRIVACY DOOR

(71) Applicant: Jamco America Inc. WA, Everett, WA (US)

(72) Inventors: Nilesh Dingankar, Bothell, WA (US); Spencer Jayoung Lee, Marysville, WA (US); Adam Junzo Fukushima, Lynnwood, WA (US); Steven Wesley Conboy, Kenmore, WA (US); Tyler Stevens Merritt, Snohomish, WA (US); John Michael Cornell, Marysville, WA (US)

(21) Appl. No.: 18/096,583

(22) Filed: Jan. 13, 2023

Related U.S. Application Data
(60) Provisional application No. 63/354,390, filed on Jun. 22, 2022.

(51) Int. Cl. B64D 11/06; B64D 11/00

(52) U.S. Cl. CPC B64D 11/0606; B64D 11/0023

(57) ABSTRACT

A flexible aircraft privacy door for a passenger cabin environment, comprising a first edge and a second edge. The flexible privacy door is configured to be slidable between a stowed position leaving an opening between spaced structures of an airplane seat and a deployed position closing the opening between the spaced structures of the airplane seat. The first edge of the flexible privacy door, when the flexible privacy door is in the deployed position, is moveable out of a plane of the opening by way of force against the flexible privacy panel. In addition, the flexible privacy door is bendable out of the plane of the airplane seat entrance up to a certain bending distance, thereby allowing a passenger to pass through the opening for ingress/egress during flight operations.

This application claims the benefit of and priority to U.S. Provisional Application No. 63/354,390, filed Jun. 22, 2022, the contents of which are hereby incorporated by reference.

### FIELD OF THE DISCLOSURE

The present disclosure generally relates to a flexible aircraft privacy door and method of using the same within an aircraft.

### BACKGROUND

Passenger privacy can be a problem in aircraft and other vehicles. In certain aircraft cabins—for instance in business class and/or first class or other premium classes—passengers are increasingly demanding privacy from other passengers sitting in close proximity to them. To satisfy such passenger needs, airlines are forced to afford larger, more spacious suites that are equipped to provide privacy from other passengers within the aircraft through various panels, doors and other cabin structures that separate the passenger in the suite from the rest of the cabin.

The multi-class cabin arrangements in certain aircraft further require specific class dividers and panels in order to efficiently separate the passengers from each other, driven primarily by passenger comfort. A feature that is particularly true for aircraft seating, especially premium seating such as first or business class seating, exists in which it may be desirable to provide seated passengers with privacy not only with respect to neighboring passengers but also with respect to an adjacent aisle. Many airlines are seeking to provide seats with privacy doors or screens, and aircraft interior designers have been tasked with making such privacy doors or screens as safe and efficient as possible.

Luxury passenger cabins are often fitted with private suites that include facilities for sitting, reclining, sleeping, dining and/or other activities. In addition, approaches to address privacy door designs require complex mechanisms in order to meet regulatory requirements for emergency egress during flight operations. The rules are intended to ensure that any evacuation is not degraded due to the presence of any privacy doors or privacy panels. Aircraft cabin suites are generally equipped with conventional privacy screens or doors that allow the screens or doors to be opened or closed as desired by the passenger. However, due to the limited space and other design limitations/configurations and passenger regulatory requirements, most of the privacy doors or screens currently available in the market are rigid and thereby lack any functionality with regard to flexibility.

Prior art configurations of privacy doors comprise panels or other rigid structures which are fixed and prone to getting jammed during flight operation. Further, such conventional panels are not configured for easy and efficient opening and closing for passenger comfort and privacy. Rather, prior art panels, doors and other cabin structures are generally required to have features to allow the passenger emergency egress from the seat without any flexibility to offer during emergency egress from the cabin suite. In order to meet safety regulations, any door positioned between the passenger and the aisle is thus desirably designed and configured such that if the primary means of egress is disabled, a secondary means of egress is provided. The general intent is to ensure that a passenger does not become trapped within the enclosed suite or mini suite, without a safe alternate egress route. Climbing over a passenger seat shell is generally not considered a safe secondary exit route. All of the foregoing issues further limit design options and/or configurations for aircraft privacy doors and panels.

In addition, there are only a few currently available examples of features making a door panel being removable (either partially or fully) and the door panel being hinged to the backshell of an airplane seat. Generally, any enclosed suite or mini suite—the term of art used to refer to a passenger seating area or space that has a privacy feature positioned between the seat and the aisle or other common area—has an enclosure with a secondary opening feature (or secondary egress) in the event that the primary opening feature (primary egress) fails in a deployed or closed position.

Even if some progress were made in designing and building flexibility in the privacy doors, they would still lack the robustness and structural reliability that is required to operate smoothly within an aircraft cabin. Certain existing privacy doors/panels—for example the Safran Versa door—end up providing too much flexibility without any structural integrity or robustness (nothing more than a cloth held taut across the opening via supports at both ends).

In sum, currently available designs and configurations of privacy doors lack the needed flexibility, maneuverability and adaptability for passenger privacy and access. Therefore, there is clearly a market need for an improved flexible aircraft privacy door for use on airplane seating products—specifically designed and configured with semirigid material overcoming the disadvantages and shortcomings of the conventional prior art privacy doors—a novel and unique flexible aircraft privacy door that can provide passenger privacy while making the overall flying experience for a passenger much more pleasurable.

The present disclosure is directed to an apparatus and method comprising an improved flexible aircraft privacy door. More particularly, the present disclosure is directed to a novel and uniquely configured flexible privacy door that provides significant performance and efficiency improvement from currently available prior art privacy screens or doors—providing privacy to a passenger while overcoming shortcomings and disadvantages of conventional aircraft privacy doors and screens.

### SUMMARY

Embodiments disclosed in the present disclosure provide a flexible aircraft privacy door and method of using the same.

In an aspect of the present disclosure, an apparatus and associated methods related to a flexible aircraft privacy door are provided—a flexible privacy door attached to the backshell of an airplane seat—shaped and configured to bend and return to its original shape when a certain minimal amount of force is applied to the privacy door. The flexible privacy door assembly for an aircraft cabin environment comprises a flexible privacy door having a first edge (e.g., leading edge) located at a distal end from a second edge (e.g. trailing edge)—the flexible privacy door coupled to a backshell of an airplane seat and moveable between a first position and a second position. In the depicted embodiment, (a) the first edge and a portion of a length of the door are moveable out of plane of an opening by way of force against the door in the second position and (b) a portion of a length of the privacy door in the second position is flexibly bendable out of the plane of an airplane seat entrance up to a certain pre-determined bending distance in order to allow at least one person to pass through the opening for ingress and/or egress during flight operations.

In another aspect of the present disclosure, the flexible privacy door can be installed proximate to a passenger seat and/or suite in an aircraft cabin and configured to partially or fully obstruct the view from outside observers into the area around the passenger seat and/or suite. The flexible privacy door comprises a first edge and a second edge located at a distal end from the first edge and wherein the door is positioned along the side of a respective seat/suite interrupting any unobstructed view of a passenger sitting inside the seat/suite as well as preventing other passengers from seeing inside the seat/suite, thereby enhancing the feeling of privacy to a passenger. The flexible privacy door disclosed herein is further configured to have a minimal or almost no impact on the existing aircraft seat structures and can be easily attached to backshells of the airplane seats currently installed in many aircraft around the world.

As further disclosed in the detailed description and illustrated in the accompanying drawings, the flexible privacy door is movable and slidable in and out of or within a wall pocket in a fore-and-aft direction between an open position (the fully retracted position leaving an opening between spaced structures of a passenger seat/suite) and a closed position (the fully deployed position) between the spaced structures of a passenger seat/suite. Further, the flexible privacy door is designed and shaped to hold its shape without external support during normal usage, the semirigid material used for the door further providing the structural integrity to hold its shape as a privacy door without any additional external support structure.

In yet another aspect of the present disclosure, the use of certain materials—by way of example and not of limitation—certain types of semirigid materials having a predetermined modulus of elasticity provides the required structural integrity and flexibility to the privacy door for passenger ingress and/or egress. For instance, the flexible privacy door can bend out of the plane of the seat/suite entrance into or out of the seat/suite up to a certain bending distance, allowing a passenger to pass through the opening for ingress/egress while providing the needed flexibility, maneuverability and adaptability for passenger privacy and access.

In another aspect of the present disclosure, a method of establishing a flexible privacy door for a passenger cabin environment is provided, the method comprising the steps of: (1) coupling the privacy door having a first edge located at a distal end from a second edge to a backshell of an airplane seat such that the door is moveable between a first position and a second position; (2) moving the first edge and a portion of a length of the door out of plane of an opening by way of force against the door in the second position; (3) flexibly bending a portion of a length of the privacy door in the second position out of the plane of an airplane seat entrance up to a certain pre-determined bending distance; and (4) allowing at least one person to pass through the opening for ingress and/or egress during flight operations.

The various embodiments of the improved flexible privacy door described herein can be configured to provide both normal and emergency-use operations of the privacy door in order to provide maximum privacy and ease of use to the passenger while maintaining emergency ingress/egress paths as well as sight lines for flight crew personnel to have a clear view of the passengers sitting in the passenger seats or suites within the aircraft cabin. Many other benefits of the embodiments described herein include providing a door that is configurable for various types of aircraft cabin and suite frameworks and improving manufacturing and installation efficiency while providing value-added cost benefits to aircraft manufacturers and airline operators.

The flexible privacy door can be designed and built in order to ensure that it can be configured to work within a certain predefined envelop size for a certain aircraft seating arrangement. The door can be manufactured using the standard TenCate Layup process and structurally embedded with metal blocks or can be manufactured using other equivalent materials and processes. Further, the flexible privacy door disclosed herein can be used with standard backshell designs having a top backshell trim.

In addition, the flexible privacy door will be primarily operable in two positions: (1) Taxi, Take-Off and Landing (TTOL); and (2) Deployed. The privacy door in the TTOL position can be configured with dual latching and a detent and in the deployed position can also be configured with a detent—the privacy door configured to go inside a cavity (or wall pocket) to address any potential misalignment issues and help reduce any related abuse load. Finally, as further described below, the flexibility of the privacy door allows a passenger emergency egress from the seat/suite without performing any additional actions; the passenger can simply push through the door with minimal effort during emergencies, allowing a simpler and more efficient design of the flexible privacy door while easing regulatory requirements for passenger aircraft.

This summary is provided to introduce a selection of concepts in a simplified form that are further described in the detailed description of the disclosure. This summary is not intended to identify key or essential inventive concepts of the claimed subject matter, nor is it intended for determining the scope of the claimed subject matter. The references made above in detail to the embodiments of the disclosure are provided by way of explanation of the disclosure, not in limitation of the disclosure. It will be apparent to those skilled in the art that various modifications and variations can be made in the present disclosure without departing from the scope or spirit of the disclosure.

Features illustrated or described as part of one embodiment can be used on another embodiment to yield a still further embodiment. Thus, it is intended that the present disclosure cover such modifications and variations as come within the scope of the appended claims and their equivalents. Other objects, features and aspects of the present disclosure are disclosed in the following detailed description. It is to be understood by one of ordinary skill in the art that the present discussion is a description of exemplary embodiments only, and is not intended as limiting the broader aspects of the present disclosure, which broader aspects are embodied in the exemplary constructions.

### BRIEF DESCRIPTION OF THE DRAWINGS

The disclosure will be more readily understood in view of the following description when accompanied by the below figures. The accompanying figures incorporated in and forming a part of the specification illustrate several aspects of the present invention and, together with the description, serve to explain the principles of the invention.

FIG. 1 illustrates an exemplary passenger suite with a flexible privacy door in a first position (fully closed or retracted position) and in a second position (fully/partially open or deployed position) and attached to the backshell of an aircraft seat as disclosed herein.

FIG. 2 illustrates an exemplary passenger suite with a flexible privacy door as disclosed herein.

FIG. 3 depicts a perspective view of an exemplary flexible privacy door in the second position (an open flexed-out position) as disclosed herein.

FIG. 4 depicts a perspective view of an exemplary flexible privacy door along with a wall pocket in a fully closed or retracted position as disclosed herein.

FIG. 5 depicts a perspective view of an exemplary flexible privacy door along with a wall pocket in a fully closed or retracted position as disclosed herein.

FIGS. 6 through 8A-B depict various embodiments along with the components of an exemplary flexible privacy door as disclosed herein.

### DETAILED DESCRIPTION OF THE DISCLOSURE

For the purposes of promoting and understanding the principles disclosed herein, reference is now made to the preferred embodiments illustrated in the drawings, and specific language is used to describe the same. The disclosure below along with drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities. It is understood that no limitation of the scope of the disclosure is hereby intended. Such alterations and further modifications in the illustrated apparatus and such further applications of the principles disclosed and illustrated herein are contemplated as would normally occur to one of ordinary skill in the art to which this disclosure relates.

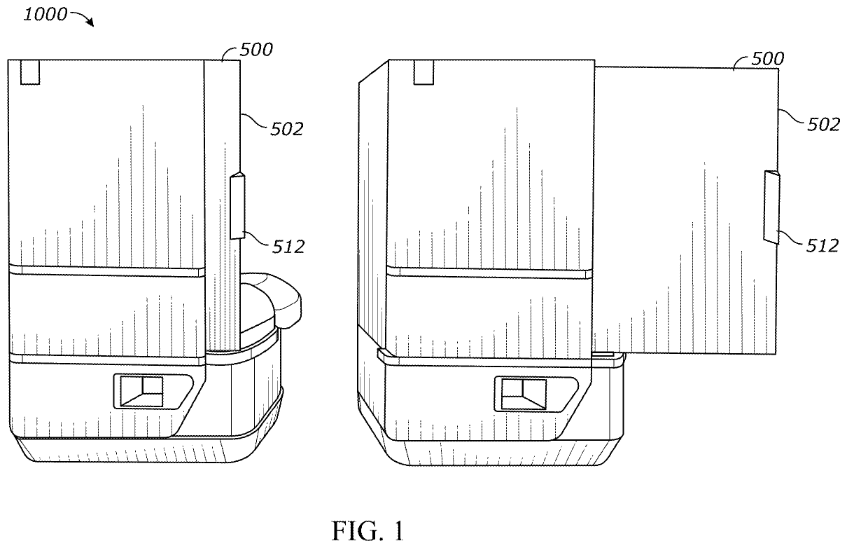

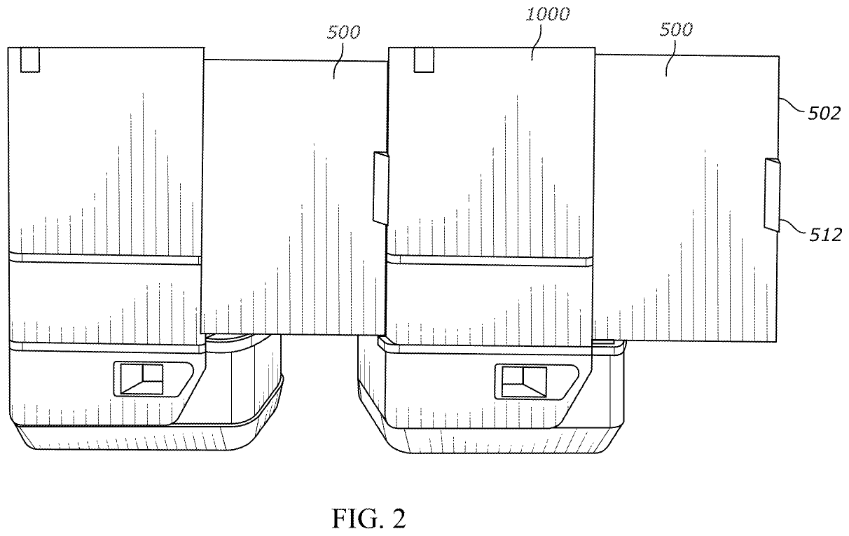

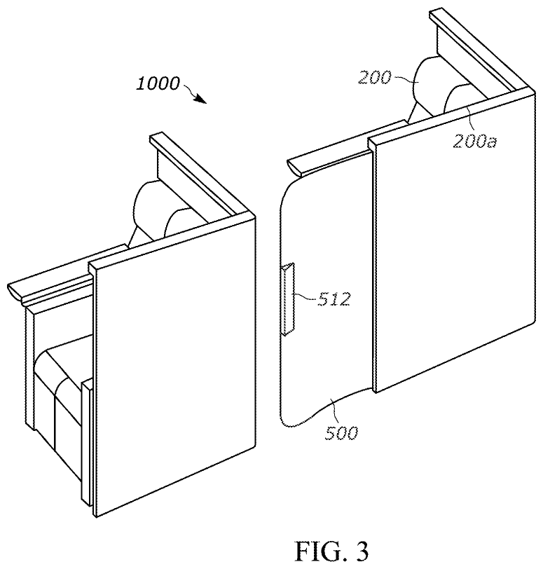

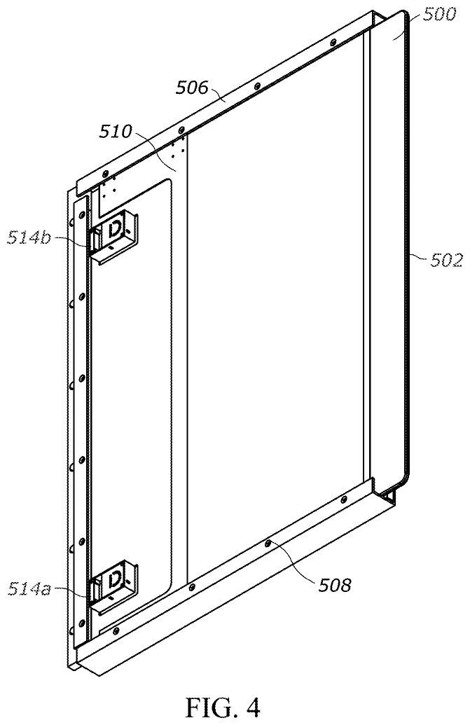

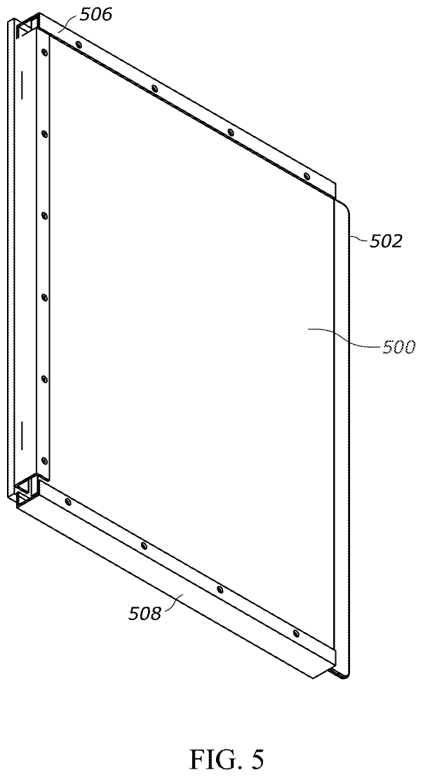

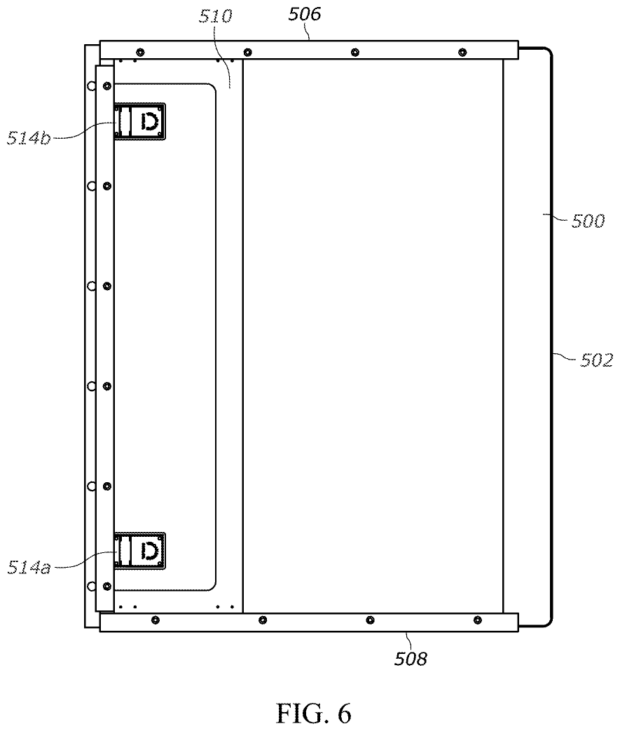

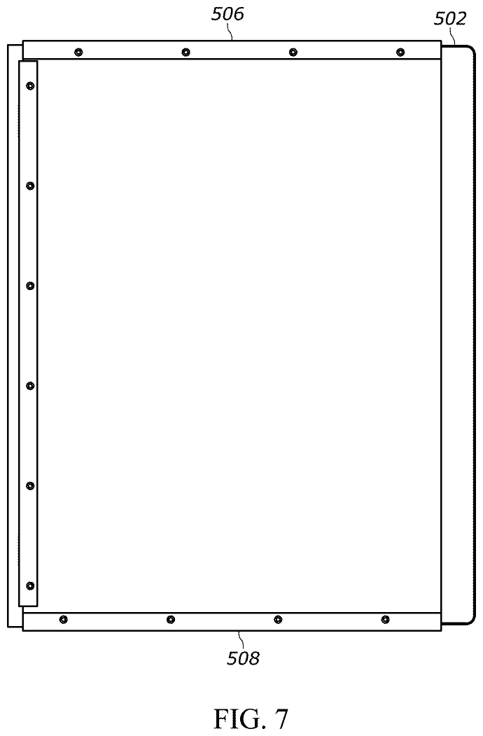

FIG. 1 illustrates an exemplary passenger suite with a flexible privacy door in a first position (fully closed or retracted position) and in a second position (fully/partially open or deployed position) and attached to the backshell of an aircraft seat as disclosed herein. FIG. 2 illustrates an exemplary passenger suite with a flexible privacy door as disclosed herein. FIG. 3 depicts a perspective view of an exemplary flexible privacy door in the second position (an open flexed-out position) as disclosed herein. FIG. 4 depicts a perspective view of an exemplary flexible privacy door along with a wall pocket in a fully closed or retracted position as disclosed herein. FIG. 5 depicts a perspective view of an exemplary flexible privacy door along with a wall pocket in a fully closed or retracted position as disclosed herein. FIGS. 6 through 8A-B depict various embodiments along with the components of an exemplary flexible privacy door as disclosed herein.

As illustrated in FIGS. 1 through 7, the flexible privacy door assembly for an aircraft cabin environment 1000 comprises a flexible privacy door 500 having a first edge 502 (e.g., leading edge) located at a distal end from a second edge (e.g. trailing edge)—the flexible privacy door coupled to a backshell of an airplane seat 200 and moveable between a first position and a second position. The first edge 502 and a portion of a length of the door 500 is moveable out of plane of an opening by way of force against the door in the second position (as shown in FIG. 3) and a portion of a length of the privacy door 500 in the second position is flexibly bendable out of the plane (also shown in FIG. 3) of an airplane seat entrance up to a certain pre-determined bending distance in order to allow at least one person to pass through the opening for ingress and/or egress during flight operations.

As further illustrated in FIGS. 1 through 7, first edge 502 of the flexible privacy door 500 and a portion of a length of the privacy door 500 in the second position is moveable out of plane of an opening by way of force against the door 500. The first position is a stowed position leaving an opening between spaced structures of an airplane seat and the second position is a deployed position closing the opening between the spaced structures of the airplane seat and the stowed position can be used during the during Taxi, Take Off and Landing (TTOL) of an aircraft.

In an aspect of the present disclosure, and as illustrated in FIGS. 4 and 5, the flexible privacy door 500 is movable and slidable in and out of or within a wall pocket in a fore-and-aft direction between a fully retracted position (TTOL) leaving an opening between spaced structures of passenger seats/suites and in a closed or fully deployed position between the spaced structures of the passenger seats/suites.

In another aspect of the present disclosure and as further illustrated in the accompanying drawings, the door 500 can be constructed from a material having a certain pre-determined modulus of elasticity in order to be deformed elastically and return to its original shape when a certain amount of force is applied to the door. As disclosed herein, the flexible privacy door 500 is further configured to be moveable in a fore-and-aft direction in and out of or within a wall pocket attached to an airplane seat structure—shown in FIGS. 4 through 6. The spaced structures are fixed walls and the opening is a suite entrance formed between the fixed walls. It is to be noted that in the depicted embodiment and as illustrated in FIGS. 1 through 7, the privacy door is positioned to reside in the plane of the suite entrance in the deployed position in order to partially or fully obstruct the view from outside observers into the area around the passenger.

In yet another aspect of the present disclosure, the flexible privacy door 500 is further configured to provide flexibility, maneuverability and adaptability for passenger privacy and access by allowing a passenger to pass through the opening of a suite entrance for ingress/egress with minimal effort. The flexible privacy door 500 can further provide sight lines for flight crew personnel to have a clear view of the passengers sitting in the passenger seats or suites within the aircraft cabin.

In still yet another aspect of the present disclosure. the wall pocket further comprises a top rail and a bottom rail located opposite the top rail for sliding the door in the fore-and-aft direction between the first and the second position. By way of example and not of limitation, the flexible privacy disclosed herein can be further configured with means for dual latching and a detent mechanism of engagement during Taxi, Take Off and Landing (TTOL) of an aircraft.

FIG. 1 illustrates an exemplary passenger suite with a flexible privacy door in a fully open or deployed position and a fully closed or retracted position and attached to the backshell of an aircraft seat as disclosed herein. FIG. 2 illustrates an exemplary passenger suite with a flexible privacy door as disclosed herein. FIG. 3 depicts a perspective view of an exemplary flexible privacy door in an open flexed-out position as disclosed herein.

As described herein and illustrated in FIGS. 1, 2 and 3, the flexible privacy door 500 installed in the aircraft passenger seating area is attached to the backshell of an airplane seat. Aircraft passenger seating area 1000 is shown as having a seat 200. In an exemplary embodiment, the seat 200 is facing in the forward direction of an airplane and is adjacent to an aisle which passengers can use to travel to and from the seat. The seat 200 is also shown as being at least partially enclosed by suite boundary 200a. As depicted, the suite boundary 200a provides at least some privacy for the occupants of the seat 200 by at least partially obstructing the view of the area around the seat 200 from observers outside of the suite boundary 200a. As illustrated in the accompanying figures, the spaced structures of the aircraft seats/suites are spaced fixed walls and the opening is a suite entrance for an aircraft seat formed between the spaced fixed walls.

As shown in FIGS. 1 through 7, the flexible privacy door 500 comprising a first edge 502 and a second edge (inside the wall pocket and not illustrated in the drawings) is moveable and slidable via a plate 512 attached to a first edge 502 of the flexible privacy door 500. The door 500 is moveable and slidable between a fully retracted or stowed position (during Taxi, Take Off and Landing (TTOL)) leaving an opening between spaced structures of an aircraft seat/suite (seating area 1000) and a deployed position closing the opening between the spaced structures of the aircraft seats/suites within the aircraft cabin. As disclosed herein, the flexible privacy door 500 is designed and configured to move out of or within a wall pocket in the seat boundary 200a. As depicted and illustrated in the figures, the flexible privacy door 500 is movable and slidable in and out of or within a wall pocket in a fore-and-aft direction between an open position leaving an opening between spaced structures of a passenger seat/suite and a closed position when fully deployed between the spaced structures of a passenger seat. The flexible privacy door 500 can be retracted within the wall pocket to achieve a stowed state during TTOL. Similarly, the flexible privacy door 500 can be extended out of the wall pocket to achieve a deployed state. The flexible privacy door 500 as shown in FIGS. 1 through 7 is designed to hold its shape without external support during normal usage, the semirigid material providing the structural integrity to hold the shape of the door 500 without any additional external support structures.

FIG. 3 illustrates the flexible door 500 designed, shaped and configured to bend in an open flexed-out position in order to allow a person to pass through the door. The flexible privacy panel is bendable out of the plane of the seat/suite (seating area 1000) entrance into or out of the seat/suite up to a certain bending distance, allowing a passenger to pass through the opening for ingress/egress while providing the needed flexibility, maneuverability and adaptability for passenger privacy and access within the aircraft cabin. One of the key advantages of the flexible privacy door 500 is that it will require a minimal use of force from a passenger and thereby prevent any potential damage to the door during ingress or egress.

It is to be noted, as disclosed herein, the improved flexible configuration of the privacy door 500 allows it to bend and return to its original shape, thereby overcoming the prior art disadvantages of rigid and inflexible door designs and negating any misalignment issues. In the depicted embodiment, the flexible privacy door 500 is constructed from a semirigid material having a predetermined elastic modulus to permit the flexible privacy door 500 to be deformed and bend elastically when a certain force is applied to the door (as illustrated in FIG. 3). In addition, the flexible privacy door is uniquely shaped and designed in order to avoid the need for any visible mechanisms for the emergency passage feature, making the privacy door disclosed herein more visually and aesthetically pleasing as illustrated in FIGS. 1 through 7. The flexible privacy door 500 also provides a convenient and efficient passenger seat ingress/egress system—a passenger seat/suite area divided from an aisle or other common area by the flexible privacy door 500—provides privacy to the passenger.

As further shown in FIG. 3, the flexibility of the privacy door 500 allows the passenger emergency egress from the seat without performing any additional actions—the passenger can simply push and bend the door, leveraging the simpler design and construction of the door 500 and easing regulatory requirements. As discussed above, if the flexible privacy door 500 is jammed and cannot be opened during an emergency the passenger can simply push and bend the door aside and walk through the opening. By way of example and not limitation, the privacy door 500 can be used in passenger suites in aircraft cabins that separate an interior of the passenger suite from the rest of the aircraft cabin. To provide ingress/egress paths from the passenger seats or suites the flexible privacy door 500 may be installed such that it can be operated in normal and emergency use applications.

During normal use or in emergency situations, the flexible privacy door 500 may be operated to either slide into or out of the wall pocket as shown in FIGS. 1 through 7, and/or flexed open by bending out of the plane of the suite (as shown in FIG. 3) without violating aisle clearance regulations. In the depicted embodiment, bending of the privacy door 500 may further be a function of the amount of force a person exerts on the door. As illustrated, the flexibility of the privacy door 500 ensures that minimum force will be needed to bend the door (flex-open) during ingress or egress. The modulus of elasticity along with the stiffness of the flexible privacy door 500 may therefore be customized to suit a person of average (or below average) human strength, such that the vast majority of passengers can effectively push open the flexible privacy door 500 without much effort on their part. For instance, when the flexible privacy door 500 is in the second position (the deployed position), the flexible privacy door 500 resides in the plane of the suite entrance, and wherein the first edge 502 of the flexible privacy door 500 and a portion of a length of the flexible privacy door 500 are moveable out of the plane of the suite entrance by way of force by a passenger against the privacy door 500. As further illustrated, in an embodiment, a partially closed flexible privacy door 500 can occupy at least part of the space in the ingress/egress point—around the passenger seating area 1000—to provide a passenger with additional privacy. As depicted, the flexible privacy door 500 is configured to at least partially obstruct the view from outside observers into the area around the seat/suite. In addition, the flexible privacy panel can also be configured in an open flexed-out position, illustrated by FIG. 3 during ingress or egress.

FIGS. 4 and 5 depict a perspective view of an exemplary flexible privacy door along with the wall pocket in a fully closed or retracted position as disclosed herein. FIGS. 6 through 8A-B depict various embodiments along with the components of an exemplary flexible privacy door as disclosed herein. As shown, the flexible privacy door 500 is captured within the wall pocket of the backshell of an airplane seat (200 and 200a). As illustrated, the privacy door 500 is configured to slide in and out of the wall pocket via top and bottom rails using a ball roller mechanism (506 and 508). In addition, pull box tabs (514a and 514b) are used to deploy and/or retract the privacy door 500 within the wall pocket of the backshell.

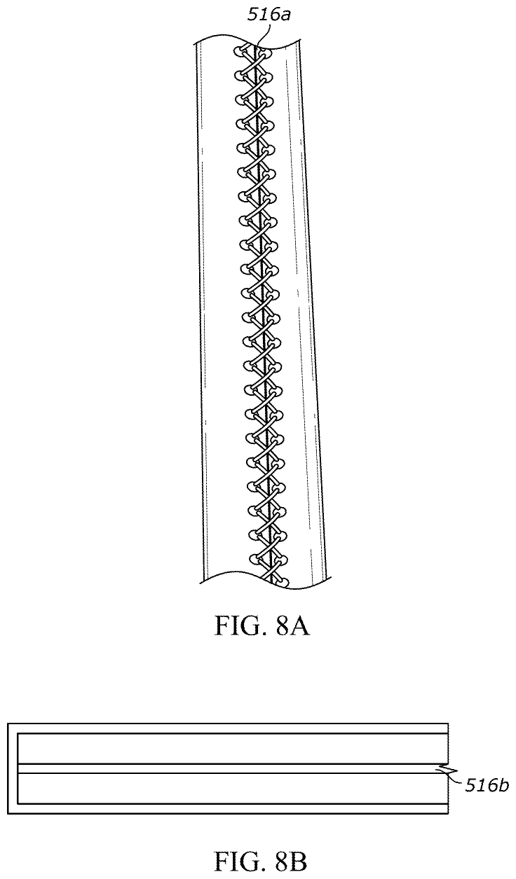

It is to be noted, by way of example and not limitation, that various types of commercial off-the-shelf pull tab boxes (e.g., Vulcan Pull Box with or without a dampener, reinforcing sheet metal stiffener (510)) can be used in various embodiments of the flexible privacy door 500. As depicted, the flexible privacy door 500 is designed to be captured within a wall pocket having the top rail 506 (comprising a ball roller mechanism) and a bottom rail 508 (also comprising a ball roller mechanism). Further, the first edge 502 of the flexible privacy door can be configured as a steel rod (magnetic latch or other similar mechanisms) or leather/foam (516a, 516b in FIGS. 8A-B) or can have other construction providing the required flexibility of bending and moving a portion of the flexible privacy door 500 out of the plane as shown in FIG. 3.

In another aspect of the present disclosure, a method of establishing a flexible privacy door 500 for a passenger cabin environment is provided, the method comprising the steps of: (1) coupling the privacy door 500 having a first edge 502 located at a distal end from a second edge (not shown in the drawing) to a backshell of an airplane seat 200 such that the door is moveable between a first position and a second position; (2) moving the first edge 502 and a portion of a length of the door out of plane of an opening by way of force against the door 500 in the second position; (3) flexibly bending a portion of a length of the privacy door 500 in the second position out of the plane of an airplane seat entrance up to a certain pre-determined bending distance; and (4) allowing at least one person to pass through the opening for ingress and/or egress during flight operations

It is understood that the preceding is merely a detailed description of some examples and embodiments of the present disclosure, and that numerous changes to the disclosed embodiments may be made in accordance with the disclosure made herein without departing from the spirit or scope of the disclosure. For instance, various embodiments of a privacy door disclosed herein can be designed and configured as a removable sliding privacy door or a hinged sliding privacy door. The terms “invention,” “the invention,” “this invention,” “the present invention,” “disclosure,” “the disclosure” and “the present disclosure” used in this patent are intended to refer broadly to all of the subject matter of this patent and the patent claims below.

Statements containing these terms should be understood not to limit the subject matter described herein or to limit the meaning or scope of the patent claims below. Embodiments of the invention covered by this patent are also defined by the claims below. In addition, “one embodiment” or “an embodiment” means that a particular feature, structure or characteristic described in connection with an embodiment is included in at least one embodiment of the subject matter disclosed.

The appearance of the phrase “in one embodiment” or “in an embodiment” in various places throughout the specification is not necessarily referring to the same embodiment. It is further understood that terms such as “interior,” “exterior,” “inner,” “outer” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions and/or points of reference as disclosed herein, and likewise do not necessarily limit embodiments of the present disclosure to any particular configuration or orientation.

The preceding description, therefore, is not meant to limit the scope of the disclosure but to provide sufficient disclosure to allow one of ordinary skill in the art to practice the disclosure without undue burden. The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. Recitation of ranges of values herein, if any, are merely intended to serve as a shorthand method of referring individually to each separate value falling within the range, unless otherwise indicated herein, and each separate value is incorporated into the specification as if it were individually recited herein.

The methods described and disclosed herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

1. A flexible privacy door for an aircraft cabin environment, the flexible privacy door comprising:
a first edge located at a distal end from a second edge, the flexible privacy door configured to be coupled to a backshell of an airplane seat and moveable between a first position and a second position;
wherein in the second position:
the first edge and a portion of a length of the door are moveable out of plane of an opening by way of force against the door; and
a portion of a length of the privacy door is flexibly bendable out of the plane of an airplane seat entrance up to a certain pre-determined bending distance in order to allow at least one person to pass through the opening for ingress and/or egress during flight operations.

2. The flexible privacy door of claim 1, wherein the first position is a stowed position leaving an opening between spaced structures of an airplane seat and the second position is a deployed position closing at least partially the opening between the spaced structures of the airplane seat; and
wherein the stowed position can be used during Taxi, Take Off and Landing (TTOL) of an aircraft.

3. The flexible privacy door of claim 1, wherein the door is constructed from a material having a pre-determined modulus of elasticity in order to be deformed elastically and return to its original shape when a certain amount of force is applied to the door.

4. The flexible privacy door of claim 1, wherein the door is further configured to be moveable in a fore-and-aft direction in and out of or within a wall pocket attached to an airplane seat structure.

5. The flexible privacy door of claim 2, wherein the spaced structures are fixed walls and the opening is a suite entrance formed between the fixed walls.

6. The flexible privacy door of claim 1, wherein the privacy door is positioned to reside in the plane of the suite entrance in the second position in order to partially or fully obstruct the view from outside into the area around the passenger.

7. The flexible privacy door of claim 1, further configured to provide flexibility, maneuverability and adaptability for passenger privacy and access by allowing at least one passenger to pass through the opening of a suite entrance for ingress/egress with minimal effort.

8. The flexible privacy door of claim 1, further providing sight lines for flight crew personnel to have a clear view of at least one passenger sitting in the passenger seat or suite within the aircraft cabin.

9. The flexible privacy door of claim 4, wherein the wall pocket further comprises a top rail and a bottom rail located opposite the top rail for sliding the door in the fore-and-aft direction between the first and the second position.

10. The flexible privacy door of claim 1, wherein the first edge further comprises a steel rod or a magnetic latch or leather foam or other similar constructions in order to provide easy maneuverability and deployment.

11. The flexible privacy door of claim 2, wherein the door can be further configured with means for dual latching and a detent mechanism of engagement with the wall pocket during Taxi, Take Off and Landing (TTOL) of an aircraft.

12. A method of establishing a flexible privacy door for an aircraft cabin environment, the method comprising the steps of:
coupling the privacy door having a first edge located at a distal end from a second edge to a backshell of an airplane seat such that the door is moveable between a first position and a second position;
moving the first edge and a portion of a length of the door out of plane of an opening by way of force against the door in the second position; and
flexibly bending a portion of a length of the privacy door in the second position out of the plane of an airplane seat entrance up to a certain pre-determined bending distance; and
allowing at least one person to pass through the opening for ingress and/or egress during flight operations.

13. The method of claim 12, wherein the first position is a stowed position leaving an opening between spaced structures of an airplane seat and the second position is a deployed position closing at least partially the opening between the spaced structures of the airplane seat; and
wherein the stowed position can be used during Taxi, Take Off and Landing (TTOL) of an aircraft.

14. The method of claim 12, wherein the door is constructed from a material having a pre-determined modulus of elasticity in order to be deformed elastically and return to its original shape when a certain amount of force is applied to the door.

15. The method of claim 12, wherein the door is further configured to be moveable in a fore-and-aft direction in and out of or within a wall pocket attached to an airplane seat structure.

16. The method of claim 12, wherein the spaced structures are fixed walls and the opening is a suite entrance formed between the fixed walls.

17. The method of claim 12, wherein the privacy door is positioned to reside in the plane of the suite entrance in the second position in order to partially or fully obstruct the view from outside into the area around the passenger.

18. The method of claim 12, further providing flexibility, maneuverability and adaptability for passenger privacy and access by allowing at least one passenger to pass through the opening of a suite entrance for ingress/egress with minimal effort.

19. The method of claim 12, further providing sight lines for flight crew personnel to have a clear view of at least one passenger sitting in the passenger seat or suite within the aircraft cabin.

20. The method of claim 12, wherein the wall pocket further comprises a top rail and a bottom rail located opposite the top rail for sliding the door in the fore-and-aft direction between the first and the second position.
